(19) United States
(12) Patent Application Publication
(10) Pub. No.: US 2017/0240383 A1
(43) Pub. Date: Aug. 24, 2017

(54) STAIRLIFT

(71) Applicant: Stannah Stairlifts Limited, Hampshire (GB)

(72) Inventor: Alexander Henry Gage Wilson, Hampshire (GB)

(73) Assignee: Stannah Stairlifts Limited, Hampshire (GB)

(21) Appl. No.: 15/512,324

(22) PCT Filed: Oct. 9, 2015
(86) PCT No.: PCT/GB2015/052970

§ 371 Date: Mar. 17, 2017

(30) Foreign Application Priority Data
Oct. 15, 2014 (GB) 1418307.3

(51) Int. Cl. B66B 9/08; A47C 3/18

(52) U.S. Cl. CPC B66B 9/0853; A47C 3/18; B66B 2009/0892

(57) ABSTRACT

The invention provides a swivel mechanism for a stairlift chair and a stairlift including such a swivel assembly. The assembly includes two swivel axes, one of which attached to the carriage and the other of which attaches to the chair. The axes are spaced and preferably geared together.

### FIELD OF THE INVENTION

This invention relates to stairlifts and, in particular, to a seat swivel mechanism for incorporation between the chair and carriage of a stairlift assembly.

### BACKGROUND TO THE INVENTION

It is known to provide a swivel mechanism on a stairlift to enable the chair to be swivelled about a substantially vertical axis. This enables the chair to be rotated at an end of the staircase in which the stairlift assembly is mounted, thus making it easier for a user to mount or dismount from the chair.

On many installations, provision is made to swivel the chair only at the top of the staircase. However, there is a demand for the chair to be capable of swivelling in both directions, thereby facilitating mounting and dismounting from the chair at both ends of the staircase. This demand presents a number of issues.

In order to accommodate swivelling in both directions on existing installations, the chair is pivoted at or close to its geometric centre. As the chair is swivelled, a significant part of the chair moves in a rearward arc and may collide with the wall of the staircase in which the assembly is mounted. To reduce the likelihood of interference with the wall, a number of solutions are currently adopted. Firstly, the pivot point of the chair may be repositioned on the carriage so that, when the stairlift is positioned in a staircase, the chair pivot is positioned further away from the wall. Secondly, the entire stairlift assembly may be positioned further away from the wall.

Whilst both of these solutions reduce the likelihood of interference with the wall, both result in the stairlift obstructing the staircase, to a greater extent, for able bodied users of the staircase.

A third approach is to reduce the width of the chair, or provide cut-outs in the chair, to reduce the size of the arc through which the extremities of the chair swing. This solution compromises the comfort of the user.

It is an object of this invention to go at least some way in addressing the limitations of existing stairlift seat swivel mechanisms as described above; or which will at least provide a novel and useful choice.

### SUMMARY OF THE INVENTION

Accordingly, in one aspect the invention consists in a swivel assembly for a stairlift chair, said swivel assembly including a first axis of rotation and a second axis of rotation substantially parallel to said first axis of rotation, said first and second axes of rotation being spaced in a direction substantially perpendicular thereto.

Preferably said axes of rotation are defined by shafts.

Preferably said shafts are located in a common housing and project from said housing in opposite directions.

Preferably said swivel assembly further includes a transmission whereby rotation about one of said axes of rotation effects rotation about the other of said axes of rotation.

In a second aspect the invention provides a stairlift chair mountable on a stairlift carriage, said chair having a swivel assembly as set forth above, wherein said swivel assembly is mountable to said carriage along said first axis and is mounted to said chair along said second axis.

Preferably said chair has a longitudinal centreline extending between front and rear edges of said chair, said second axis being fixed to said chair along said longitudinal centreline.

In a third aspect the invention provides a stairlift including:

a stairlift rail;

a carriage mounted on said rail for movement along said rail;

a chair mounted on said carriage;

a swivel assembly as set forth above mounted between said chair and said carriage to permit said chair to swivel relative to said carriage.

Preferably said chair has a longitudinal centreline and a travel position in which said longitudinal centreline is aligned substantially perpendicular to said rail, wherein said first and second axes of rotation are arranged along said longitudinal centreline when said chair is in said travel position.

Preferably said chair has a front edge and a rear edge, said second axis being located closer to the rear edge of said chair than said first axis.

Many variations in the way the present invention can be performed will present themselves to those skilled in the art. The description which follows is intended as an illustration only of one means of performing the invention and the lack of description of variants or equivalents should not be regarded as limiting. Wherever possible, a description of a specific element should be deemed to include any and all equivalents thereof whether in existence now or in the future.

### BRIEF DESCRIPTION OF THE DRAWINGS

One working embodiment of the invention will now be described with reference to the accompanying drawings in which:

FIG. 1: shows a plan view of part of a stairlift installation including a swivel mechanism according to the invention;

FIG. 2: shows a side elevation of that which is shown in FIG. 1; and

FIG. 3A to 3C: show diagrammatic views of a stairlift chair swivelling between a travelling position and a swiveled embarking/dis-embarking position.

### DETAILED DESCRIPTION OF WORKING EMBODIMENT

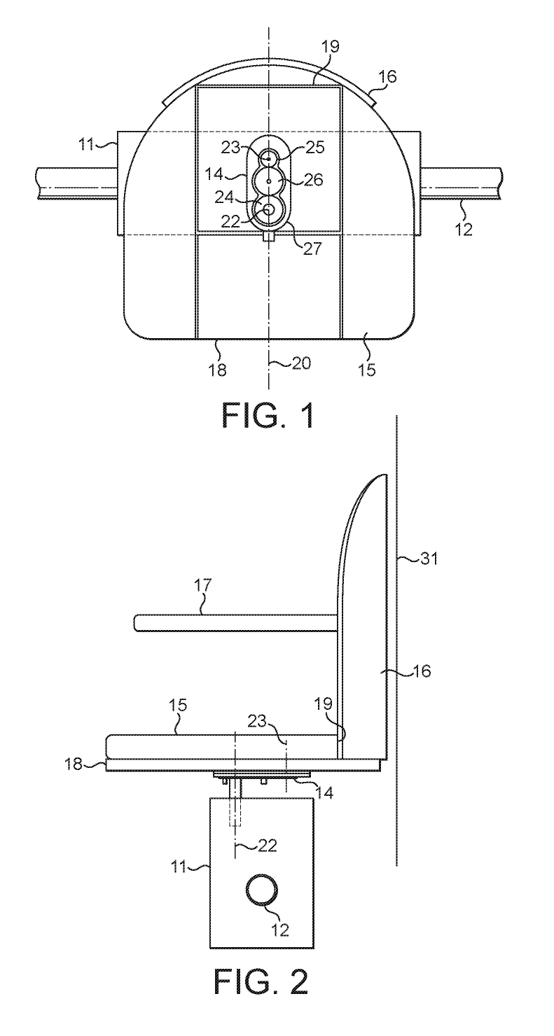

Referring to the drawings a stairlift installation is shown having a carriage 11 mounted on a rail 12. A chair 13 is mounted on the carriage via a swivel assembly 14 to enable the chair to be swivelled relative to the carriage from the normal straight-ahead travelling position shown in FIGS. 1 & 3A, in a manner that will be described in greater detail below. The chair 13 has a seat base 15, a backrest 16 and armrests 17. As can be seen in FIG. 1, the seat base 15 has a front edge 18, a rear edge 19 and a longitudinal centreline 20 extending through and between the front and rear edges.

The essence of the invention lies in the arrangement of the swivel assembly 14 which has two spaced axes of rotation. A first axis of rotation 22 defines the swivel connection between the carriage 11 and the swivel assembly 14, while a second axis of rotation 23 defines the swivel connection between the swivel assembly 14 and the chair 13. The positions of axes 22 and 23 are preferably fixed with respect to one another.

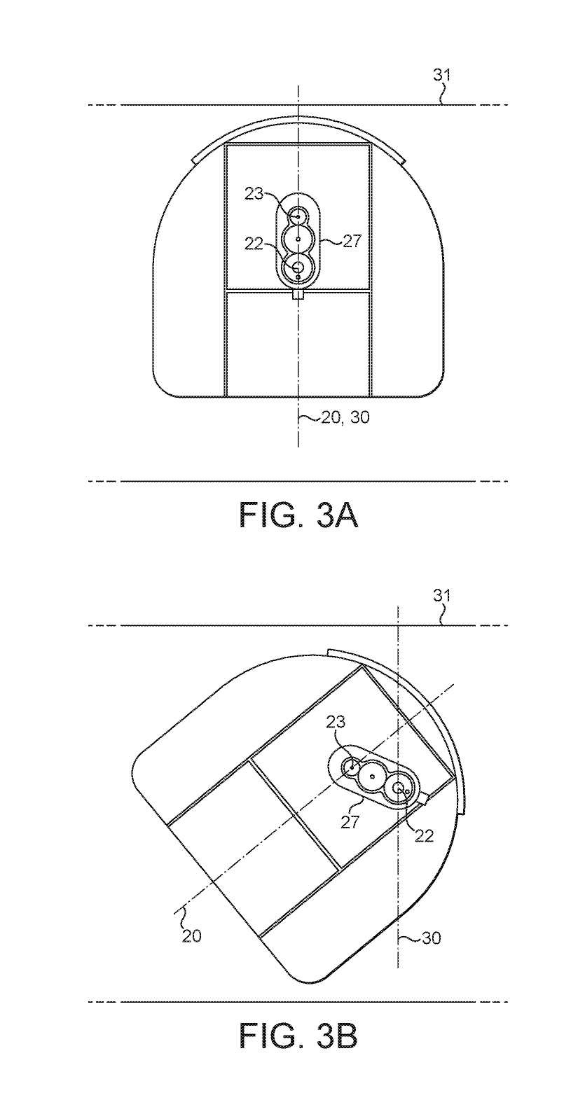

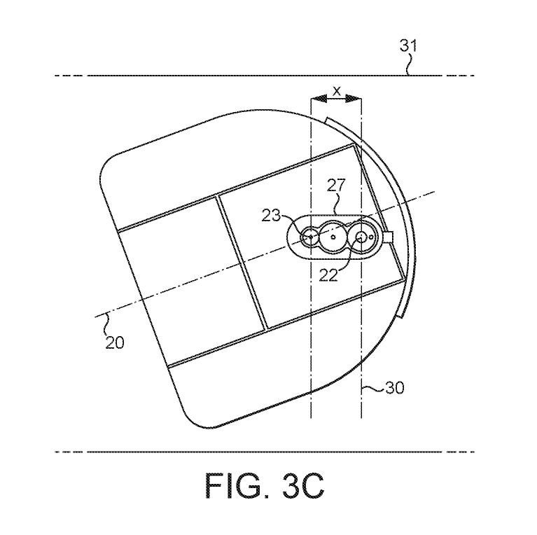

As is apparent from FIG. 2, a shaft is mounted on the axis 22 that projects downwardly from the swivel assembly 14 to engage the carriage. The chair is mounted on a rotating boss (not shown) projecting from the upper surface of the swivel assembly on axis 23. It will also be appreciated that the axes 22 and 23 are spaced apart. When the chair is in the normal travel position shown in FIGS. 1 and 3A, both axes 22 and 23 preferably lie substantially on the longitudinal centreline 20 of the chair but the axis 23 is closer to the rear edge 19 of the chair, than the axis 22.

The swivel assembly 14 preferably further includes a form of transmission between the two axes 22 and 23 so that rotation around one of the axes effects rotation about the other. In the form shown this transmission comprises a gear 24 mounted on the axis 22, a gear 25 mounted on the axis 23 and an idler gear 26 located between, and in mesh with, the gears 24 and 25. The gears 24, 25 and 26 may be mounted in a housing 27 that is located between and attaches to, both the carriage 11 and the chair 13, the shaft defining axis 22 projecting below the housing 27 and the rotating boss on axis 23 projecting from the upper surface of the housing 27.

Turning now to FIGS. 3A to 3C, the chair is shown swivelling between the conventional travelling position shown in FIG. 3A and the fully-swivelled position shown in FIG. 3C. In order to understand the invention, it is convenient to observe the movement of the longitudinal centreline 20 of the chair relative to a reference axis 30 which is perpendicular to the line of the rail 12 and passes through the first axis of rotation 22.

When the chair 13 is in the normal travel position, the centreline 20 overlies the reference axis 30. When gear 24 is rotated in a clockwise direction, the gear 25 is also rotated in a clockwise direction causing the chair to swivel to the left as shown in FIGS. 3B and 3C. It will be seen that, as the chair is swivelled, the backrest 16 is drawn away from wall 31 thus overcoming a major problem experienced when the chair is mounted on its centreline, namely the backrest colliding with the wall. It will also be seen that, when swivelled, the chair is displaced a distance x from the reference axis which eases entry to, and exit from, the chair at the end of the rail.

The arrangement shown in FIGS. 3A to 3C is appropriate for swivelling at the bottom of the rail 12. At the top of the rail, the gear 24 would be rotated in a counter-clockwise direction, causing the chair 13 to be swivelled in the opposite direction.

It will be appreciated that, by changing the ratio of the gearing between the gears 24 and 25, and by changing the spacing between the axis 22 and 23, the available swivel angle and seat projection, when swivelled, can be varied.

1. A swivel assembly for a stairlift chair, said swivel assembly including a first axis of rotation and a second axis of rotation substantially parallel to said first axis of rotation, said first and second axes of rotation being spaced apart in a direction substantially perpendicular to the first and second axes.

2. A swivel assembly as claimed in claim 1, wherein the swivel assembly comprises at least one shaft and at least one of said axes of rotation is defined by one of the at least one shaft.

3. A swivel assembly as claimed in claim 2, wherein:
the at least one shaft comprises two shafts, each shaft defining one of said axes of rotation; and
a common housing, said shafts being located in the common housing and projecting from the common housing in opposite directions.

4. A swivel assembly as claimed in claim 1, further including a transmission whereby rotation about one of said axes of rotation effects rotation about the other of said axes of rotation.

5. A stairlift chair mountable on a stairlift carriage, said chair having a swivel assembly as claimed in claim 1, wherein said swivel assembly is mountable to said carriage along said first axis and is mounted to said chair along said second axis.

6. A stairlift chair as claimed in claim 5, having a longitudinal centerline extending between front and rear edges of said chair, said second axis being fixed to said chair along said longitudinal centerline.

7. A stairlift including:
a stairlift rail;
a carriage mounted on said rail for movement along said rail;
a chair mounted on said carriage; and
a swivel assembly as claimed in claim 1 mounted between said chair and said carriage to permit said chair to swivel relative to said carriage.

8. A stairlift as claimed in claim 7, wherein said chair has a longitudinal centerline and a travel position in which said longitudinal centerline is aligned substantially perpendicular to said rail, wherein said first and second axes of rotation are arranged along said longitudinal centerline when said chair is in said travel position.

9. A stairlift as claimed in claim 7, wherein said chair has a front edge and a rear edge, said second axis being located closer to the rear edge of said chair than to said first axis.
